(19) United States
(12) Patent Application Publication
(10) Pub. No.: US 2010/0159083 A1
(43) Pub. Date: Jun. 24, 2010

(54) CONTAINER FOR COOKING FOODSTUFFS AND METHOD OF MANUFACTURING THE SAME

(75) Inventors: Mark Peplinski, Whitchurch (GB); David Moorcroft, Hampton (GB)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Steamfast Europe Lane, Hampton Cheshire (GB)

(21) Appl. No.: 11/993,802

(22) PCT Filed: Jun. 22, 2006
(86) PCT No.: PCT/GB2006/002280

§ 371 Date: Dec. 21, 2007

(30) Foreign Application Priority Data
Jun. 24, 2005 (GB) 0512889.7

(51) Int. Cl. B65D 81/34; B32B 37/00; H05B 6/80; B65D 33/01

(52) U.S. Cl. 426/113; 156/292; 219/727; 383/100

(57) ABSTRACT

A bag or pouch container for use in cooking foodstuffs in a microwave oven, comprising two sheets of plastics material bonded or welded together along its edges (2) to define a foodstuff receiving and/or containing interior and being closed or closable to permit cooking under pressure i.e. at above atmospheric pressure, said sheets also being bonded or welded together along a bonding line or lines (4) extending between edge regions to define one or more compartments (5, 6) within the container for receiving and/or containing foodstuffs or other contents, with said line or lines being separable or rupturable at a desired temperature and/or pressure to permit flow of one foodstuff into the other compartment, and a pressure relief valve or means (17) operable to relieve pressure within the container during cooking whilst permitting cooking to continue thereafter at a pressure above atmospheric pressure.

The present invention concerns improvements in or relating to cooking containers for use in cooking foodstuffs, particularly microwave cooking of foodstuffs wherein.

There are several cooking containers in the marketplace which are usually in the form of bags or pouches, and contain foodstuffs sealed therewithin. Such containers are usually rectangular in shape and are suitably formed of plastics film material, preferably laminated. Also, many known containers are open to atmosphere i.e. they do not enable cooking with the food contents being under the pressures which are created by heating to effect cooking i.e. they operate substantially at atmospheric pressure.

A problem associated with such containers is that same are not suitable for use with foodstuffs or food products which may interact with one another during storage of the cooking container prior to cooking, suitably in a microwave oven.

In JP 2003-237852 DAINIPPON PRINTING CO. LTD: there is disclosed a container formed from a single sheet of material with two compartments and a venting valve but which does not appear to cook at above atmospheric pressure after the pressure relief vent has opened.

It is an object of the present invention to provide a cooking container which may be used in connection with cooking of mixed foodstuffs or food products which generally require to be kept apart prior to cooking.

According to the present invention there is provided a cooking container for permitting cooking of foodstuffs at above atmospheric pressure, suitably in the form of a bag or pouch, and preferably of substantially rectangular form, such container being sealed around the outer edging thereof, such container including means to enable multi-compartments or chambers to be provided in such container, whereby, in use, different foodstuffs or food products are kept separate from one another in said compartments or chambers prior to cooking and as cooking takes place such means, at a selected time and/or temperature and/or pressure enables or allows the separate foodstuffs or food products to mix with one another.

The cooking container of the invention may have any number of compartments but preferably contains two separate chambers or compartments. The container is particularly suitable for packaging of foodstuffs or food products that consist of or contain meat and a sauce. In this connection, such foodstuffs or food products often cannot be stored together because of the interactions which occur between the sauce and the meat, e.g. chicken, while the packaging is stored prior to cooking.

The means for separating the foodstuffs or food products in accordance with the invention preferably comprises a welded or bonded strip or line of the plastics material from which the container is made and forming a seam which extends across the packaging from one edge to an opposite edge thereof, e.g. from top to bottom or side to side when the upper side is resealable. The strength of such bonding strip is such that, during cooking, when the pressure builds up within the separate chambers or compartments, the separating strip or seam is forced apart, separating the inner surfaces of the container, thereby allowing the previously separated foods to mix with one another during the cooking process. The frangible or releasable or peelable nature of the bonding line is preferably achieved by forming the container of two sheets of different plastics materials such that a layer of a peelable nature faces a layer of a weldable nature (polypropylenes, for example exhibit such characteristics) and then by applying different welding operations a peelable seam line may separate the compartments and will be separable at a lower pressure than the peripheral edge seals bonding the two sheets together to form the container. Examples of combinations from which the bag may be formed of comprise laminated sheet material of polyester and polypropylene or polyester and polyethylene (with the polyester being on the outside). Additionally or separately, the separable seam lines may be of less width than the edge seals to cause separation thereof and a lower pressure.

The cooking container of the invention is suitably in the form of a bag or pouch or envelope and is preferably of substantially rectangular form. The container is suitably formed having high strength bonding nature of material in the outer edge regions thereof which is capable of withstanding high pressures that are generated and maintained when the food within the container is cooked, suitably in a microwave oven, the contents of the container also possibly expanding during cooking.

The cooking container of the present application may be packaged by the supplier thereof to retail outlets with both of the distinct food types already being contained in separate compartments in the container.

In an embodiment of the invention it is possible that the cooking container may be supplied with only one foodstuff or food product, for example the sauce, being retained within a first chamber or compartment, and then having a second chamber or compartment which is empty and which can be filled by the user prior to cooking. In such case, means would also be provided in the edging portion of the container relative to such empty compartment to permit such compartment to be filled and thereafter sealed. Such arrangement would thereby enable the user to insert their particular choice of meat or other foodstuff or food product into the empty compartment of the cooking container.

Whilst reference has been made to two chambers or compartments in the cooking container of the invention, it is possible to use more than two chambers or compartments when more than two foodstuffs or food products require to be separated.

The invention also provides a method of forming a cooking container in accordance with the present invention wherein the bonding strip or layer is held or bonded to one interior surface of the container and thereafter applied to the other interior surface of the container to create distinct chambers or compartments for the cooking container of the invention.

Various modifications can be made to the cooking container in accordance with particular requirements for each type of cooking which is to take place.

In accordance with the present invention the cooking container is provided with valve or venting means which, when the container is being heated and the pressure builds up, allows the pressure to be reduced and said suitable venting means become operational when the pressure within the container reaches a selected level, enabling the pressure built up to be reduced but not to permit any foodstuffs or food products to escape from the container, and whilst maintaining a pressure within the container during continued cooking. Reference is made to EP 0661219 PACKS CO. LTD.

Once the cooking has been completed then the container can then be opened and the contents are then available to the user.

Also according to the present invention there is provided an improved bag or pouch container for use in cooking foodstuffs in a microwave oven, comprising two sheets of plastics material bonded or welded together along its edges to define a foodstuff receiving and/or containing interior and being closed or closable to permit cooking under pressure i.e. at above atmospheric pressure, said sheets also being bonded or welded together to form at least one seam along a bonding line or lines extending between edge regions to define one or more compartments within the container for receiving and/or containing foodstuffs or other contents, with said line or lines being separable or rupturable at a desired temperature and/or pressure to permit flow of one foodstuff into another compartment, and pressure relief valve or means operable to relieve pressure within the container during cooking whilst permitting cooking to continue thereafter at a pressure above atmospheric pressure.

The present invention will be described further, by way of example, with reference to the accompanying drawings, in which:—

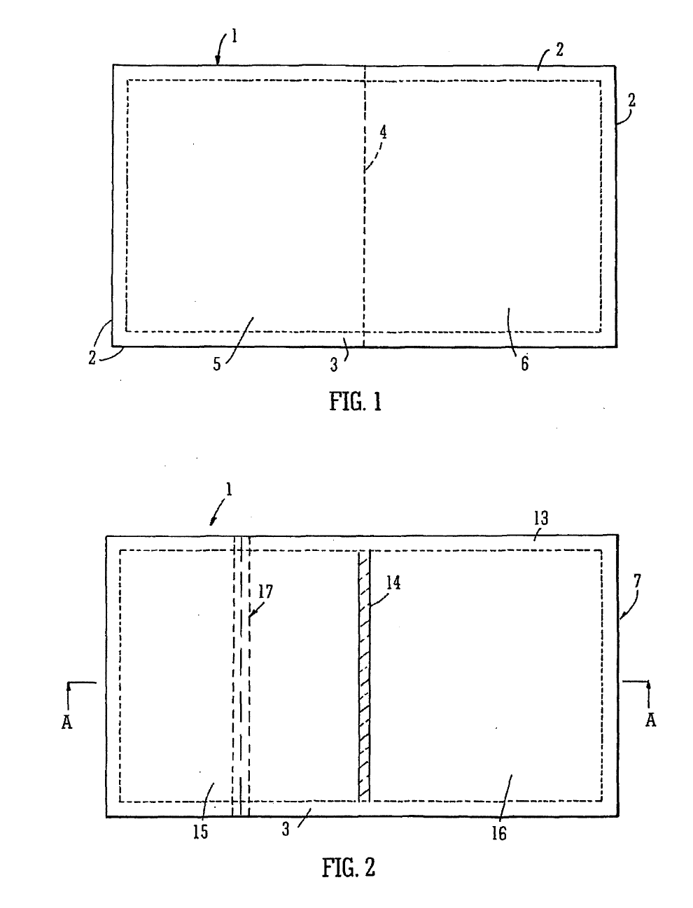

FIG. 1 is a schematic plan view of a cooking container in accordance with a first embodiment of the present invention;

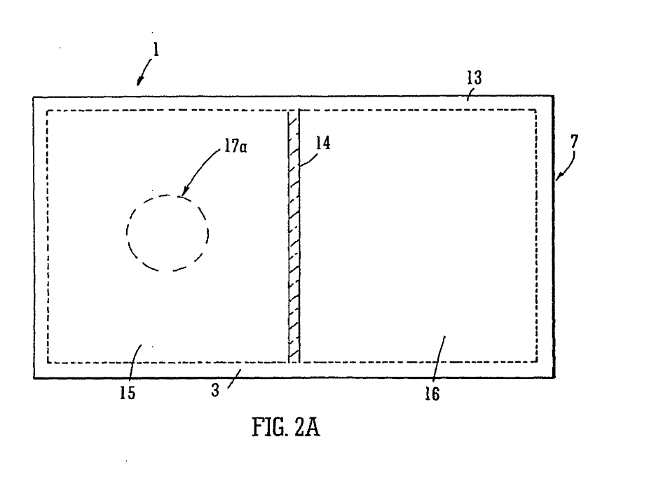

FIG. 2 is a view of a container similar to that of FIG. 1 but illustrating schematically the location of one type of pressure relief means for one compartment;

FIG. 2A illustrates an alternative type of pressure relief valve means;

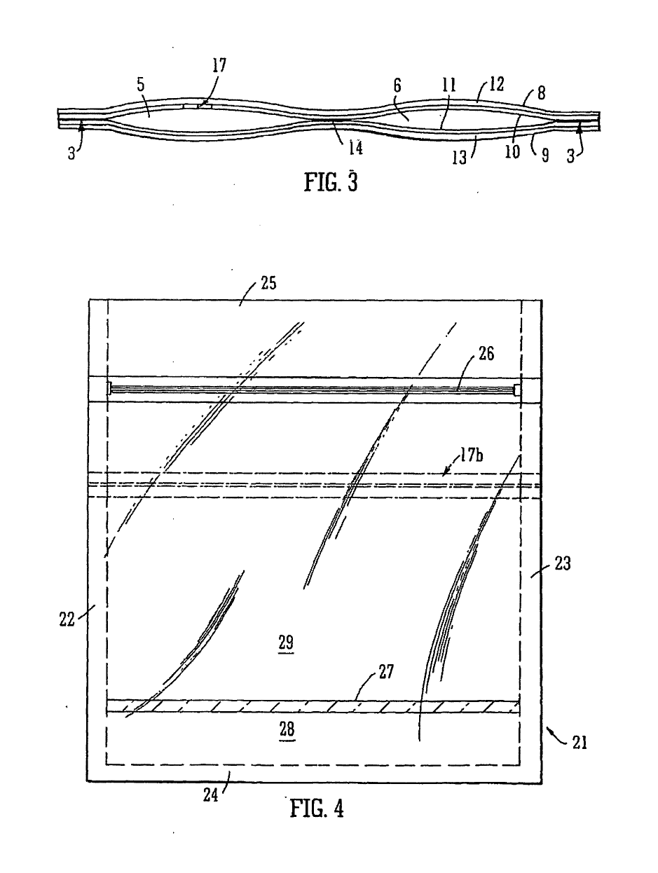

FIG. 3 is a schematic illustration of the layers of a container showing the edge welds and a different central weld;

FIG. 4 is a schematic plan in view of an alternative embodiment wherein the container is closeable and re-openable by the user.

As illustrated in FIG. 1, a cooking container for permitting food to be cooked therein in a microwave oven in accordance with a first embodiment of the invention comprises a substantially rectangular cooking bag 1 formed of two sheets of laminated plastics material film welded together so as to be sealed along its four sides 2 (apart from any pressure relief means where provided of such a nature to extend through part of the side welds). The welded-together edge seams or portions 3 define a region within which foodstuffs or food products can be located for cooking in a microwave oven.

A releasable bonding line or strip 4 is provided as a seam which separates or divides the container into two separate chambers or compartments 5 and 6 and is formed by a peelable bond between the sheets.

In a preferred use of this embodiment, one chamber or compartment 5 is filled with meat or other suitable foodstuff or food product and the other chamber or compartment 6 is filled with sauce. During cooking, the bonding line or strip 4, when a desired pressure is reached, is forced apart and separates the previous contact between the interior surfaces of the sheets of the container 1 and enables communication between the compartments 5 and 6 and thereby enabling the two foodstuffs or food products contained in the chambers or compartments 5 and 6 to mix together and be cooked together.

The cooking bag will suitably be provided with appropriate venting means or pressure relief means in order to enable vapour to escape from the bag when the pressure builds up during cooking but such as to maintain a pressure within the container during cooking.

When cooking is completed, the cooking container is removed from the microwave oven and then can be opened up e.g. by cutting to enable the mixed and cooked foodstuffs or food products to be removed therefrom.

In the slightly more detailed embodiments of FIGS. 2, 2A and 3, a sealed container 7 for enabling cooking of the contents in a microwave oven is schematically illustrated and is also such that, in use, during cooking the interior is under pressure created by the cooking heat. The container comprises a pouch made from two laminated films or sheets of flexible sheet material 8, 9 bonded together with adhesive and with one, inner laminated layer 10 of one sheet 8 being of a peelable nature e.g. a peelable polypropylene, and the other, inner laminated layer 11 of the other sheet 9 being of a weldable nature e.g. a weldable polypropylene. (Other materials having appropriate characteristics may be used such as described in our copending UK Application No. 0606338.7).

Thus one film or sheet 8 may comprise an outer laminate layer 12 of, e.g. polyester of e.g. 12 micron thickness and an inner laminate layer 10 of e.g. a peelable polypropylene of e.g. 50 micron and the other sheet 9 may comprise an outer laminate layer 13 e.g. also of polyester of e.g. 12 micron and an inner layer 11 of e.g. a weldable polypropylene of e.g. 40 micron. The layers of each sheet are held together by a lacquer or adhesive.

The outer peripheral sides of the sheets 8 and 9 are also heat sealed together along the whole or substantially the whole of the periphery at a temperature and pressure to form sealed peripheral edge regions 13 which are of non-peelable nature or peelable with a high force or force higher than that required for compartment dividing seams (14).

Extending between the longer of two opposite side regions 13, the sheets 8 and 9 are sealed together along a narrow seam or sealing line 14 of a more peelable nature than the edge seams e.g. by being sealed at tower temperature and/or pressure than the edge regions, to form two separate compartments 15, 16 within the container for containing different foodstuffs (not shown either). The seam or sealing line 14 is also of narrower width than the heat sealed regions 13 to possibly also constitute to a more ready peeling of such and to act to encourage such to peel first. One of the compartments 15 has a pressure relief valve/means or vent 17 of known type formed in and of the films or sheets 8, 9 e.g. by the inner layer being slit across its width and an absence of adhesive along most of the length of the slit apart from the ends where there is a layer of lacquer provided running through the edge weld which will release pressure at the ends of the slit to atmosphere at a certain pressure but still maintain a pressure within the container thereafter. The pressure relief valve/means might be located in compartment 16 instead but is preferably not in the compartment which is to contain liquid. FIG. 2A illustrates the outline of an alternative type of known pressure relief valve means 17 which is provided centrally of the compartment 15.

An alternative embodiment is illustrated in FIG. 4, comprises a container 21 formed of laminate sheets similar to 8, 9 such as mentioned above bonded together by adhesive and being welded together along opposite side regions 22, 23 and at bottom side 24 but with the upper opposite side 25 being open although closeable by a releasable seal 26 located inward of the edge region such as a press-fit seal or zipper e.g. as described in copending UK Application No. 0606338.7.

In this embodiment the releasable or peelable seal 27 is provided (similar to 4 and 14 previously described) extending as shown between side weldings 22, 23 and dividing the container into compartments 28, 29. Compartment 28 will have a pre-selected foodstuff e.g. a sauce (not shown) located therein prior to formation of peelable bonding line or strip weld 27 and the compartment is such as to receive another preferable non-liquid foodstuff e.g. chicken, selected by the user which is then sealed in by closing seal/strip 26 prior to insertion into a microwave oven.

A pressure relief valve or vent means 17b is provided to extend, between sides 22, 23 in compartment 29, to avoid such otherwise being clogged by sauce or other liquid foodstuff, and is such that after relieving excess pressure will maintain the foodstuff at a pressure above atmospheric during contained cooking.

Of course, the containers may contain products other than foodstuffs.

1. A bag or pouch or like container especially for microwave cooking of food under pressure, and which is sealed around the outer edges or sides thereof, said container including a plurality of compartments or chambers, the compartments or chambers being separated by releasable or separable bonding means, whereby, in use, different foodstuffs or food products located or locatable within the different compartments are kept separate from one another in said compartments or chambers prior to cooking and once cooking commences, said bonding means are such that at a predetermined time and/or temperature and/or pressure the bonding means releases to open the compartments to each other to enable or allow the separate foodstuffs or food products of mix with each another.

2. A bag or pouch container for use in cooking foodstuffs in a microwave oven, comprising two sheets of plastics material bonded or welded together along its edges to define a foodstuff receiving and/or containing interior and being closed or closable to permit cooking under pressure i.e. at above atmospheric pressure, said sheets also being bonded or welded together along a bonding line or lines extending between edge regions to define one or more compartments within the container for receiving and/or containing foodstuffs or other contents, with said line or lines being separable or rupturable at a desired temperature and/or pressure to permit flow of one foodstuff into the other compartment, and a pressure relief valve or means operable to relieve pressure within the container during cooking whilst permitting cooking to continue thereafter at a pressure above atmospheric pressure.

3. A container as claimed in claim 1, in which the container is of substantially rectangular form.

4. A cooking container as claimed in claim 1, having two chambers or compartments.

5. A container as claimed in claim 1, in which one compartment is to contain meat or fish and the other includes a sauce.

6. A container as claimed in claim 1, in which the bonding means comprises a welded or bonded strip or line of the plastics material from which the container is made and which extends across the packaging from one edge or side to an opposite edge or side thereof.

7. A container as claimed in claim 6, in which the strength of the bonding strip is such that, during cooking, when the pressure builds up within the separate chambers or compartments, the separating strip or bond is forced apart separating or rupturing the inner surfaces of the container, thereby allowing the previously separated foods to mix with one another during the cooking process.

8. A container as claimed in claim 7, in which the frangible or releasable or peelable nature of the bonding strip or line is achieved by forming the container walls of two sheets of different plastics materials such that a layer of a peelable nature faces a layer of a weldable nature and then by applying different welding or bonding operations a peelable line may be formed to separate the compartments and is separable at a lower pressure than that for peripheral edge seals bonding the two sheets together to form the container.

9. A container as claimed in claim 8, in which the two sheets comprise one sheet having an outer laminate layer of polyester and an inner laminate layer of a peelable polypropylene and the other sheet comprises an outer laminate layer also of polyester and an inner layer of a weldable polypropylene or polyethylene.

10. A container as claimed in claim 1, in which the container is suitably formed having high strength bonding nature of material in the outer edge regions thereof which is capable of withstanding high pressures that are generated and maintained when the food within the container is cooked with the contents of the container also possibly expanding during cooking.

11. A container as claimed in claim 1, wherein pre-packaged different foods already contained in at least two separate compartments of the container.

12. A container as claimed in claim 1, wherein pre-packaged with only one foodstuff or food product being retained within a first chamber or compartment, and wherein a second chamber or compartment which is empty and which can be filled by the user prior to cooking, in which means and provided in the edge portion of the container relative to such empty compartment to permit said compartment to be filled or loaded and thereafter sealed.

13. A container as claimed in claim 12, in which an operable and resealable closure seal is provided to enable loading of the empty compartment.

14. A container as claimed in claim 1, in which the valve or venting means when the container is heated and the pressure builds up within the compartment, is such as to allow the pressure to be reduced.

15. A container as claimed in claim 14, in which the valve or venting means maintains the pressure within the container at above atmospheric pressure during subsequent cooking.

16. A container as claimed in claim 15, in which said venting means becomes operational when the pressure within the container reaches a selected level, enabling the pressure built up to be reduced but not to permit any foodstuffs or food products to escape from the cooking container whilst maintaining a pressure within the container during cooking.

17. A container as claimed in claim 1, in which the width of the bonding line or seam is less than the width of the edge seals and such as to cause such to peel or rupture under pressure prior to the edge seals.

18. A container as claimed in claim 1, including a pressure relief valve or means in at least one compartment which preferably does not contains a liquid foodstuff.

19. (canceled)

20. A method of forming a container for cooking food in a microwave oven wherein a bonding strip or layer is held or bonded to one interior surface of the container and thereafter applied to the other interior surface of the container to create distinct chambers or compartments for the cooking container of the invention.
